(19) United States
(12) Patent Application Publication
(10) Pub. No.: US 2012/0170696 A1
(43) Pub. Date: Jul. 5, 2012

(54) RECEIVER

(75) Inventors: Kentaro TANIGUCHI, Yokohama-shi (JP); Koichiro Ban, Kawasaki-shi (JP)

(73) Assignee: KABUSHIKI KAISHA TOSHIBA, Tokyo (JP)

(21) Appl. No.: 13/417,720

(22) Filed: Mar. 12, 2012

Related U.S. Application Data
(63) Continuation of application No. PCT/JP2009/004708, filed on Sep. 18, 2009.

(51) Int. Cl. H04B 1/10

(52) U.S. Cl. 375/346

(57) ABSTRACT

A receiver includes: a first mixer that generates an in-phase signal from a received signal; a second mixer that generates a quadrature signal from the received signal; a first A/D converter that converts the in-phase signal into a digital in-phase signal; a second A/D converter that converts the quadrature signal into a digital quadrature signal; a calculator that calculates an addition/subtraction quantity based on a correction quantity, which is based on an amplitude value of the digital in-phase signal or the digital quadrature signal, and a quantization error of the first A/D converter or the second A/D converter; and an addition/subtraction unit that adds or subtracts the addition/subtraction quantity to or from the digital in-phase signal or the digital quadrature signal.

### CROSS REFERENCE TO RELATED APPLICATION(S)

This is a Continuation Application of PCT Application No. PCT/JP2009/004708, filed on Sep. 18, 2009, which was published under PCT Article 21(2) in Japanese, the entire contents of which are incorporated herein by reference.

### FIELD

One or more embodiments of the present invention relate to a receiver.

### BACKGROUND

A method in which rough adjustment is performed by an analog amplification circuit and fine adjustment is performed by a digital amplification circuit has been disclosed as a method for correcting IQ imbalance in a small-scale and low-price configuration in a quadrature demodulation type wireless receiving apparatus (see JP-A-2001-211218, for instance). The digital amplification circuit disclosed in JP-A-2001-211218 is constituted by a multiplier and an adder, which play a role in subsidiarily correcting a part which cannot be corrected by the analog amplification circuit. Therefore, it will go well if the digital amplification circuit can correct a narrow range, so that the digital amplification circuit can be implemented as a small-scale circuit.

However, the aforementioned IQ imbalance correction system is processing using a multiplier. Therefore, the circuit scale is still large. Particularly, for a wireless receiving apparatus using parallel processing to achieve high-speed signal processing, it is necessary to array a plurality of multipliers. Therefore, the circuit scale and the power consumption may increase.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a diagram showing a receiver 1 according to a first exemplary embodiment.

FIG. 2 is a diagram showing a concept of signal power correction according to the first exemplary embodiment.

FIG. 3 is a diagram showing a receiver 2 according to a second exemplary embodiment.

FIG. 4 is a diagram showing a threshold calculator 216 according to the second exemplary embodiment.

FIG. 5 is a diagram showing a concept of signal power correction according to the second exemplary embodiment.

FIG. 6 is a diagram showing a threshold calculator 316 according to a first modification of the second exemplary embodiment.

FIG. 7 is a diagram showing a receiver 4 according to a third exemplary embodiment.

FIG. 8 is a diagram showing a receiver 5 according to a second modification of the third exemplary embodiment.

FIG. 9 is a diagram showing a receiver 6 according to a fourth exemplary embodiment.

### DETAILED DESCRIPTION OF THE EMBODIMENTS

According to one embodiment, there is provided a receiver including a first mixer, a second mixer, a first A/D converter, a second A/D converter, a calculator, and an addition/subtraction unit. The first mixer generates an in-phase signal from a received signal. The second mixer generates a quadrature signal from the received signal. The first A/D converter converts the in-phase signal into a digital in-phase signal. The second A/D converter converts the quadrature signal into a digital quadrature signal. The calculator calculates an addition/subtraction quantity based on a correction quantity, which is based on an amplitude value of at least one of the digital in-phase signal and the digital quadrature signal, and a quantization error of at least one of the first A/D converter and the second A/D converter. The addition/subtraction unit adds or subtracts the addition/subtraction quantity to or from at least one of the digital in-phase signal and the digital quadrature signal.

Exemplary embodiments of the invention will be described below with reference to the drawings. Incidentally, parts referred to by the same numerals correspondingly among the following exemplary embodiments are considered to perform similar operation, and redundant description thereof will be omitted.

### First Exemplary Embodiment

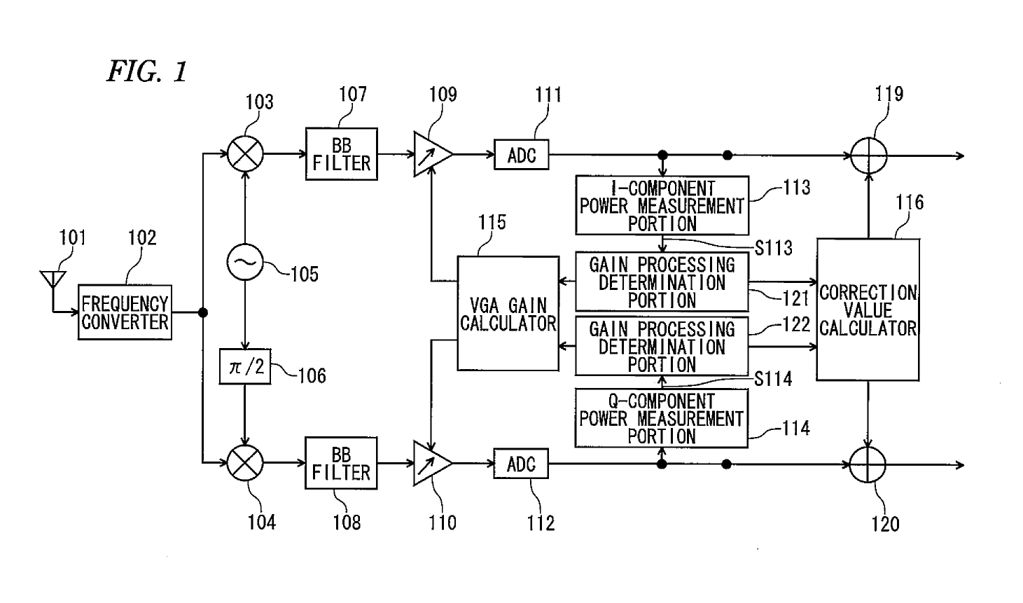

FIG. 1 shows a receiver 1 according to a first exemplary embodiment of the invention. The receiver 1 has an antenna 101, a frequency converter 102, mixers 103 and 104, a local oscillation circuit 105, a 90-degree phase shifter 106, base band filters (BB filters) 107 and 108, Variable Gain Amplifiers (VGAs) 109 and 110, A/D converters 111 and 112, an I-component power measurement portion 113, a Q-component power measurement portion 114, gain processing determination portions 121 and 122, a VGA gain calculator 115, a correction value calculator 116, and adders 119 and 120.

The antenna 101 receives a radio signal transmitted by a not-shown communication counterpart. The frequency converter 102 converts the radio signal down to an intermediate frequency to generate an IF signal. The mixer 103 mixes the IF signal with a local signal generated by the local oscillation circuit 105 to generate an I signal (in-phase signal). The mixer 104 mixes the IF signal with a local signal 90-degree phase-shifted by the 90-degree phase shifter 106 to generate a Q signal (quadrature signal).

The BB filter 107 generates an I-BB signal with a desired frequency band from the I signal. The BB filter 108 generates a Q-BB signal with a desired frequency band from the Q signal. The VGA 109 amplifies the I-BB signal with a gain calculated by the VGA gain calculator 115 to generate an amplified I signal. The VGA 110 amplifies the Q-BB signal with a gain calculated by the VGA gain calculator 115 to generate an amplified Q signal. The A/D converter 111 converts the amplified I signal, which is an analog signal, into a digital signal to generate a digital I signal. The A/D converter 112 converts the amplified Q signal, which is an analog signal, into a digital signal to generate a digital Q signal.

The I-component power measurement portion 113 measures power of the digital I signal and generates an I-component power signal S113 indicating the measured power. The Q-component power measurement portion 114 measures power of the digital Q signal and generates a Q-component power signal S114 indicating the measured power.

The gain processing determination portion 121 determines whether gain adjustment in the VGA 109 has been completed or not based on the I-component power signal S113. When determination is made that the gain adjustment in the VGA 109 has not been completed, the gain processing determination portion 121 outputs the I-component power signal S113 to the VGA gain calculator 115. When determination is made that the gain adjustment in the VGA 109 has been completed, the gain processing determination portion 121 outputs the I-component power signal S113 to the correction value calculator 116.

The gain processing determination portion 122 determines whether gain adjustment in the VGA 110 has been completed or not based on the Q-component power signal S114. When determination is made that the gain adjustment in the VGA 110 has not been completed, the gain processing determination portion 122 outputs the Q-component power signal S114 to the VGA gain calculator 115. When determination is made that the gain adjustment in the VGA 110 has been completed, the gain processing determination portion 122 outputs the Q-component power signal S114 to the correction value calculator 116.

As means for determination in the gain processing determination portions 121 and 122, for example, predetermined numbers of times of gain adjustment are counted by a counter, or determination is made based on differences between the I-component power signal S113 and a predetermined target value and between the Q-component power signal S114 and a predetermined target value.

The VGA gain calculator 115 calculates gain signals for gain adjustment in the VGAs 109 and 110 based on the I-component power signal S113 and the Q-component power signal S114.

The correction value calculator 116 calculates correction values of the digital I signal and the digital Q signal based on the I-component power signal S113 and the Q-component power signal S114. The correction values to be calculated will be described later in detail.

The adder 119 adds the correction value calculated by the correction value calculator 116 to the digital I signal to generate an added I signal. The adder 120 adds the correction value calculated by the correction value calculator 116 to the digital Q signal to generate an added Q signal. The added I signal and the added Q signal are subjected to signal processing by a not-shown digital processing portion and converted into data or the like.

Control of power in the I signal and the Q signal is adjusted by the VGAs 109 and 110 in the analog portion and adjusted by the adders 119 and 120 in the digital portion. The adjustment in the analog portion is intended to true up the power of the I signal and the power of the Q signal in conformity to dynamic ranges of the A/D converters 111 and 112 while the adjustment in the digital portion is intended to prevent the power of the I signal and the power of the Q signal from scattering due to the incompleteness of the analog circuits. It is desired to perform correction not only to prevent the powers from scattering but also to make the average power of the I signal and the average power of the Q signal agree with predetermined power values. For example, the incompleteness of the analog circuits mentioned herein includes parasitic capacitances of the circuits, gain setting errors in the VGAs 109 and 110, individual differences of the A/D converters 111 and 112, etc.

Next, details of a correction value calculated by the correction value calculator 116 will be described. Differently from the signal power adjustment in the analog portion, the signal power adjustment in the digital portion is restricted to the number of bits expressing a signal.

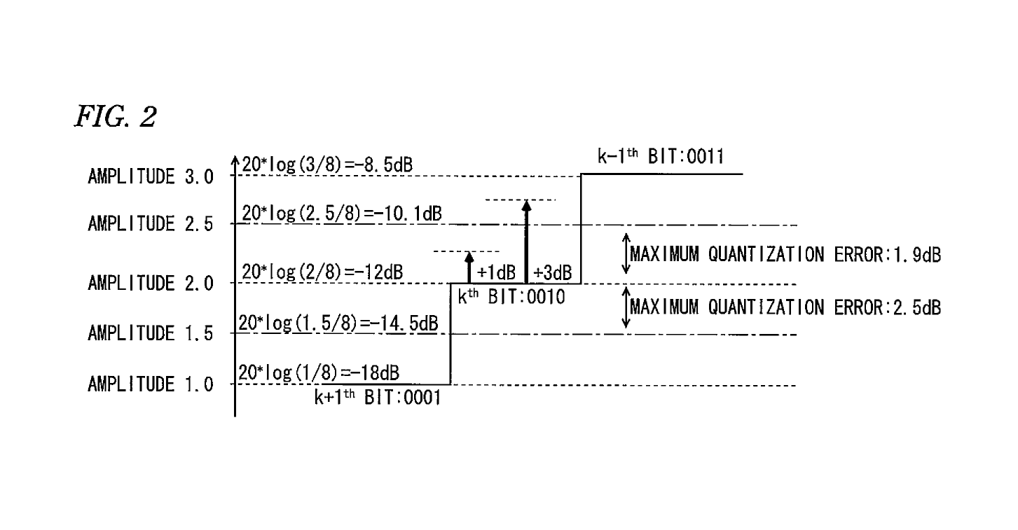

FIG. 2 is a diagram showing an example of power adjustment of a 4-bit digital signal. A signed 4-bit signal using two's complement can express 15 different values from −8 to +7. FIG. 2 shows an example in the case in which power correction of +1 dB or +3 dB is performed on 3 different 4-bit signals from +1 to +3. As shown in FIG. 2, when three different digital signals from 0001 to 0011 are normalized with 8 which is the maximum amplitude, the power of each of the signals can take a discrete value from about −18 dB to about −8.5 dB. When correction of +1 dB or +3 dB is performed on the three different digital signals, strictly, it is necessary to perform the correction in such a manner that each signal is multiplied by a correction coefficient corresponding to a correction quantity so as to expand the number of bits large enough to express a result of the multiplication. However, an accurate result of the multiplication cannot be obtained if there is a limit on the number of bits in a correction output.

As shown in FIG. 2, when signal power correction of +1 dB is performed on 4-bit input and output, a result of the correction is rounded to a level which can be expressed by 4 bits. Assume that a bit value indicating a k^{th} largest amplitude value is a k^{th} bit value. Specifically, even when power correction of +1 dB is performed on the k^{th} bit value in this case, the same k^{th} bit value (0010 in FIG. 2) as that before the correction is obtained as a result of the correction because +1 dB as a correction value is within a range of a maximum quantization error of the k^{th} bit value (0010). Incidentally, in FIG. 2, assume that the range of the maximum quantization error in the k^{th} bit value is from (amplitude value indicated by the k^{th} bit value−amplitude value indicated by a k−1^{th} bit value)/2 to (amplitude value indicated by a k+1^{th} bit value−amplitude value indicated by the k^{th} bit value)/2. Specifically, when a power value of about −12 dB indicated by the k^{th} bit value (0010) is set as reference, the maximum quantization error in the k^{th} bit value ranges from −2.5 dB to 1.9 dB.

As shown in FIG. 2, when signal power correction of +3 dB is performed on the k^{th} bit (0010) with 4-bit input and output, a k+1^{th} bit value (0011) in which +1 is added to the k^{th} bit value is obtained as a result of the correction. This is because +3 dB which is a correction value is out of the range of the maximum quantization error of the k^{th} bit value (0010 in FIG. 2).

In this manner, correction is not applied or +0 is added when the correction quantity is within the range of the maximum quantization error in the k^{th} bit value, and +1 bit or more or −1 bit or less is added when the correction quantity is out of the range of the maximum quantization error.

Addition of +s is applied when a power value obtained as a result of correction of a correction quantity G [dB] performed on the k^{th} bit value is within a range of a maximum quantization error of a k+s^{th} bit value, and addition of −t (or subtraction of t) is applied when the power value is within a range of a maximum quantization error of a k−t^{th} bit value. Each of k, s and t is an integer which is not smaller than 1 and not larger than n. Incidentally, n is a normalized number of maximum amplitude, and n=8 in the example of FIG. 2.

The correction value calculator 116 compares the I-component power signal S113 with a target power value and calculates a correction quantity. The correction value calculator 116 calculates an addition/subtraction quantity based on the correction quantity and the quantization error of the A/D converter 111. In the example of FIG. 2, the addition/subtraction quantity is +0 when the correction quantity is +1 dB, and the addition/subtraction quantity is +1 when the correction quantity is +3 dB. In the same manner, the correction value calculator 116 compares the Q-component power signal S114 with a target power value and calculates a correction quantity. The correction value calculator 116 calculates an addition/subtraction quantity based on the correction quantity and the quantization error of the A/D converters 111 and 112. Incidentally, the correction quantity may be a value obtained by comparing the I-component power signal S113 and the Q-component power signal S114 and dividing the difference between the two signals by 2.

Whenever the correction value calculator 116 calculates a correction quantity, the correction value calculator 116 determines whether the correction quantity is within a range of a maximum quantization error or not, and calculates an addition/subtraction quantity. Alternatively, a table indicating the relationship between correction quantities and addition/subtraction quantities may be prepared in a not-shown memory in advance so that the correction value calculator 116 can calculate an addition/subtraction quantity from a correction quantity with reference to the table.

In the aforementioned manner, according to the first exemplary embodiment, an addition/subtraction quantity is calculated based on the correction quantity and the quantization error of the A/D converter 112 so that IQ imbalance on the digital I signal or the digital Q signal can be corrected using not a multiplier but an adder. Thus, the IQ imbalance can be corrected without use of a multiplier that is high in power consumption and large in circuit scale, so that a receiver which is low in power consumption and small in circuit scale can be provided.

### Second Exemplary Embodiment

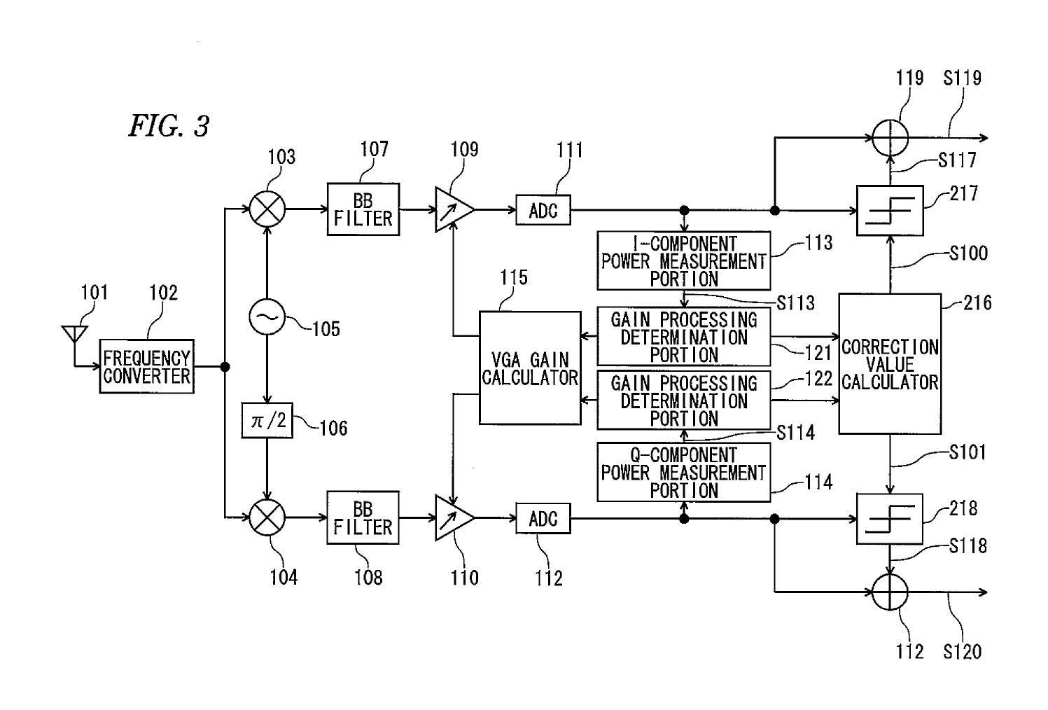

FIG. 3 shows a receiver 2 according to a second exemplary embodiment of the invention. An IQ imbalance correction system in the case in which the quantization error of each A/D converter 111, 112 is defined on a true value scale has been described in the first exemplary embodiment. However, an IQ imbalance correction system in the case in which the quantization error is defined on a logarithmic scale will be described in this exemplary embodiment.

The true value scale means the case in which the maximum quantization error in each bit value is a constant value, while the logarithmic scale means the case where the maximum quantization error in each bit value logarithmically decreases or increases with increase of the bit value.

The receiver 2 has a threshold calculator 216 in place of the correction value calculator 116 in FIG. 1. Further, the receiver 2 has comparators 217 and 218.

The threshold calculator 216 calculates a first threshold S100 and a second threshold S101 based on the I-component power signal S113 and the Q-component power signal S114.

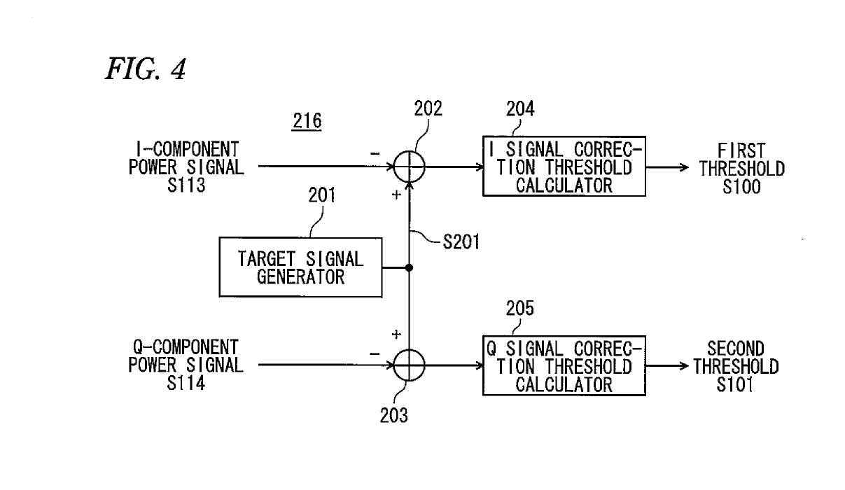

The details of the threshold calculator 216 will be described with reference to FIG. 4. The threshold calculator 216 is provided with a target signal generator 201, differentiators 202 and 203, an I signal correction threshold calculator 204, and a Q signal correction threshold calculator 205.

In the target signal generation portion 201, a target signal S201 set in advance for correcting the power of the I signal and the power of the Q signal is generated. In the differentiator 202, a difference between the I-component power signal S113 and the target signal S201 is calculated as a correction quantity and outputted to the I signal correction threshold calculator 204. In the I signal correction threshold calculator 204, a threshold corresponding to the correction quantity is calculated and outputted as the first threshold S100 to the comparator 217.

In the same manner, in the differentiator 203, a difference between the Q-component power signal S114 and the target signal S201 is calculated as a correction quantity and outputted to the Q signal correction threshold calculator 205. In the Q signal correction threshold calculator 205, a threshold corresponding to the correction quantity is calculated and outputted as the second threshold S101 to the comparator 218.

When a correction quantity is large, a plurality of thresholds are outputted as “first thresholds S100” and “second thresholds S101” to the comparators 217 and 218. The details of the first thresholds S100 and the second thresholds S101 will be described later.

Return to FIG. 3. In the comparator 217, processing of comparison in amplitude value between the first threshold S100 and the digital I signal is performed, and a comparison output S117 is outputted. When the first threshold consists of M thresholds T1, T2, . . . , TM, a value selected from +0, ±1, . . . , ±M correspondingly to the result of the comparison with the amplitude of the digital I signal and the sign of the correction quantity is outputted as the comparison output S117.

When the first threshold S100 is a bit value, the comparator 217 may compare the amplitude value of the digital I signal with the amplitude value indicated by the bit value, or may compare the digital I signal with the first threshold S100 directly. In the case of the comparison in amplitude value, the comparator 217 outputs a value selected from +1 to +M as the comparison output S117 when the amplitude value of the digital I signal is larger than the amplitude value indicated by the first threshold S100 and the digital I signal is a positive number. The comparator 217 outputs a value selected from −1 to −M as the comparison output S117 when the amplitude value of the digital I signal is larger than the amplitude value indicated by the first threshold S100 and the digital I signal is a negative number. The comparator 217 outputs +0 as the comparison output S117 when the amplitude value of the digital I signal is not larger than the amplitude value indicated by the first threshold S100.

On the other hand, consider the case of the comparison in bit value. In this case, when the digital I signal is a positive number, the comparator 217 outputs a value selected from +1 to +M as the comparison output S117 if the digital I signal is larger than the first threshold, and outputs +0 as the comparison output S117 if the digital I signal is not larger than the first threshold. When the digital I signal is a negative number, the comparator 217 outputs a value selected from −1 to −M as the comparison output S117 if the digital I signal is smaller than the first threshold, and outputs +0 as the comparison output S117 if the digital I signal is not smaller than the first threshold.

The comparison output S117 is inputted to the adder 119 as an addition/subtraction quantity. In the adder 119, processing of addition between the addition value S117 and the digital I signal is performed to correct the amplitude of the digital I signal. The adder 119 generates an added I signal. When the addition value S117 is a negative value (−M), the adder 119 adds −M to the digital I signal, that is, subtracts M from the digital I signal.

Processing of addition is performed on the digital Q signal in the same manner. That is, in the comparator 218, processing of comparison between the second threshold and the amplitude of the digital Q signal is performed and a comparison output S118 is outputted as an addition value. In the adder 120, processing of addition of the addition value S118 to the Q signal is performed to correct the amplitude of the Q signal. The adder 120 generates an added Q signal. The processings performed by the comparator 218 and the adder 120 are the same as the processings performed by the comparator 217 and the adder 119, when only the digital I signal and the first threshold are replaced by the digital Q signal and the second threshold respectively. Therefore, detailed description thereof will be omitted.

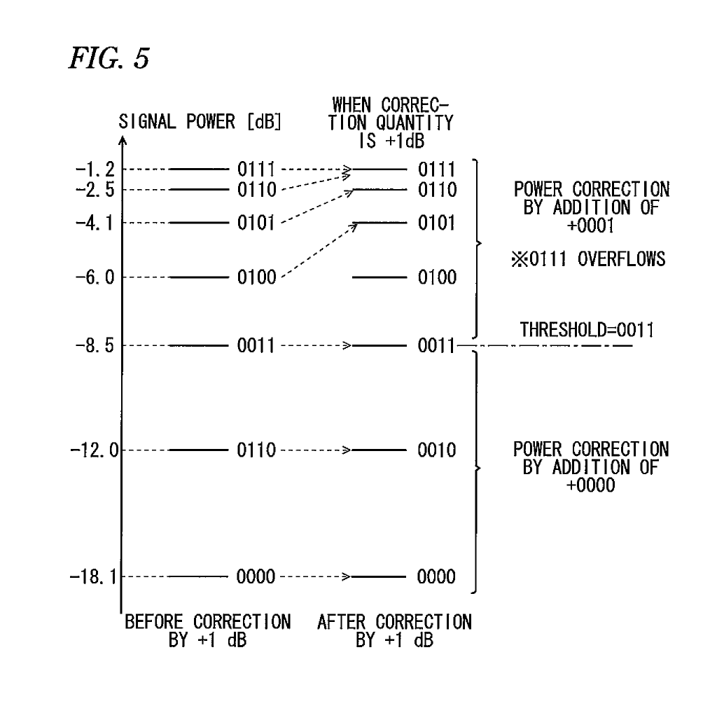

The details of the first threshold S100 and the second threshold S101 will be described with reference to FIG. 5. FIG. 5 is a diagram showing an example of power adjustment on 4-bit digital signals. FIG. 5 is a diagram showing an example in the case in which power correction of +1 dB is performed on seven different 4-bit signals from +1 to +7. As shown in FIG. 5, when the seven different digital signals from 0001 to 0111 are normalized with 8 which is the maximum amplitude, the power of each of the signals takes a discrete value ranging from about −18.1 dB to about −1.2 dB. In the example of FIG. 5, correction with +0 is applied to each signal not larger than 0011, and correction with +1 is applied to each signal larger than 0011. Thus, power correction processing of +1 dB is performed. The threshold (0011 in the case of FIG. 5) based on which the addition value for correction should be changed is determined uniquely based on the number of bits and the correction quantity.

How to calculate the first threshold S100 will be described more specifically. The amplitude of a signed N-bit digital signal using two's complement can take 2N−1+1 different values expressed by 2N−1−k (k=0, . . . , 2N−1). An amplitude difference Δ(k) [dB] between a k^{th} bit value and a k−1^{th} bit value counting from the maximum amplitude can be expressed in the following expressions.

[Expression 1]

Δ(k)≡P(k−1)−P(k) (1)

[Expression 2]

P(k)≡20 log₁₀ {⁽²^{^{N-1}}^{-k)}/₂_{^{N-1}}} (2)

A first threshold S100-1 for a positive correction quantity G [dB] is determined based on the relationship between the amplitude difference Δ(k) expressed by Expression (1) and the correction quantity G. The amplitude value does not have to be adjusted when the amplitude difference Δ(k) is two or more times as large as the correction quantity G. On the contrary, the amplitude value has to be corrected by addition of +1 when the amplitude difference Δ(k) is less than two times as large. Incidentally, when the correction quantity G is negative, similar discussion can be established if Expression (1) is re-defined as amplitude difference between the k^{th} bit value and the k+1^{th} bit value counting from the maximum amplitude.

The first threshold S100-1 with an addition quantity varying from +0 to +1 is defined by Expressions (3) and (4).

$$\begin{matrix}[ Expression 3 ] & \\ {T}_{1} = {2}^{N - 1} - {k}_{1} & ( 3 ) \\ [ Expression 4 ] & \\ {k}_{1} = {min}_{k} \{ \frac{Δ ( k )}{2} \geq G \vert k = 1 , 2 , … , {2}^{N - 1} \} & ( 4 )\end{matrix}$$

The first threshold S100-1 with an addition quantity varying from +0 to +1 is T1 in Expression (3). Amplitude correction of +1 or more is performed on the digital I signal whose amplitude is larger than the first threshold S100-1. The output of the adder 119 has no change in the case of the digital I signal whose amplitude is not larger than the first threshold S100-1. That is, amplitude correction of +0 is performed.

Here, the range of the maximum quantization error in the k^{th} bit value is set from (amplitude value indicated by the k^{th} bit value−amplitude value indicated by the k−1^{th} bit value)/2 to (amplitude value indicated by the k+1^{th} bit value−amplitude value indicated by the k^{th} bit value)/2. Thus, the first threshold S100-1 is determined based on whether the amplitude difference Δ(k) is two or more times as large as the correction quantity G or not. That is, the k^{th} bit value indicating the k^{th} largest amplitude value is set as the first threshold S100-1 when the correction quantity G is within the range of the maximum quantization error in the k^{th} bit value which is the k^{th} largest but is out of the range of the maximum quantization error in the bit value which is the k−1^{th} largest.

When the correction quantity G is large, the processing of +1 is not sufficient, but the amplitude is corrected further to a higher amplitude level. A first threshold S100-2 based on which the addition quantity is changed from +1 to +2 is defined by Expressions (5) and (6).

$$\begin{matrix}[ Expression 5 ] & \\ {T}_{2} = {2}^{N - 1} - {k}_{2} & ( 5 ) \\ [ Expression 6 ] & \\ {k}_{2} = {min}_{k} \{ \frac{Δ ( k - 1 )}{2} + Δ ( k ) \geq G > \frac{Δ ( k )}{2} \vert k = 2 , … , {2}^{N - 1} \} & ( 6 )\end{matrix}$$

The first threshold S100-2 is T2 in Expression (5). The first threshold S100-2 satisfies (first threshold S100-2)>(first threshold S100-1). The adder 119 carries out amplitude correction of +2 on a digital I signal whose amplitude is larger than the first threshold S100-2. The adder 119 carries out amplitude correction of +1 on a digital I signal whose amplitude is not larger than the first threshold S100-2 but is larger than the first threshold S100-1. The adder 119 carries out amplitude correction of +0 on an input signal whose amplitude is not larger than the first threshold S100-1. In the same manner, a threshold based on which the addition value should be changed from +(M−1) to +M is defined by Expressions (7) and (8).

$$\begin{matrix}[ Expression 7 ] & \\ {T}_{M} = {2}^{N - 1} - {k}_{M} & ( 7 ) \\ [ Expression 8 ] & \\ {k}_{M} = {min}_{k} \{ \begin{matrix}\frac{Δ ( k - M + 1 )}{2} + {\sum }_{i = 0}^{M - 2} Δ ( k - i ) \geq G > \\ \frac{Δ ( k - M + 2 )}{2} + {\sum }_{i = 0}^{M - 3} Δ ( k - 1 ) \vert k = 3 , … , {2}^{N - 1}\end{matrix} \} & ( 8 )\end{matrix}$$

Incidentally, M is an integer not smaller than 3. The adder 119 carries out amplitude correction of +M on a digital I signal whose amplitude is larger than a first threshold S100-M. The adder 119 carries out amplitude correction of +(M−1) on a digital I signal whose amplitude is not larger than the first threshold S100-M but is larger than a first threshold S100-(M−1). That is, on the assumption that ΔA designates an amplitude difference between a k^{th} largest amplitude value and a k−M^{th} largest amplitude value, the addition/subtraction quantity which should be added to a k^{th} bit value is set as “M” when a difference ΔG between the amplitude difference ΔA and the correction quantity G is within the range of the maximum quantization error of a k−M^{th} bit value.

In addition, assume that ΔA1 designates an amplitude difference between a k−1^{th} largest amplitude value and a k−M−1^{th} largest amplitude value, and ΔG1 designates a difference between the amplitude difference ΔA1 and the correction quantity G. In addition, assume that ΔA2 designates an amplitude difference between the k^{th} largest amplitude value and the k−M^{th} largest amplitude value, and ΔG2 designates a difference between the amplitude difference ΔA2 and the correction quantity G. The threshold calculator 216 sets the k^{th} bit value indicating the k^{th} largest amplitude value as the first threshold when ΔG1 is within the range of the maximum quantization error of a k−M−1^{th} bit value and ΔG2 is out of the range of the maximum quantization error of the k−M^{th} bit value.

Further, assume that ΔA3 designates an amplitude difference between a t−1^{th} largest amplitude value and a t−M−2^{th} largest amplitude value, and ΔG3 designates a difference between the amplitude difference ΔA3 and the correction quantity G. In addition, assume that ΔA4 designates an amplitude difference between the t^{th} largest amplitude value and the t−M−1^{th} largest amplitude value, and ΔG4 designates a difference between the amplitude difference ΔA4 and the correction quantity G. The threshold calculator 216 sets a t^{th} bit value indicating the t^{th} largest amplitude value as another first threshold when ΔG3 is within the range of the maximum quantization error of a t−M−2^{th} bit value and ΔG4 is out of the range of the maximum quantization error of the t−M−1^{th} bit value. In this manner, the threshold calculator 216 calculates a plurality of first thresholds. Each of k, t and M is an integer which is not smaller than 1 and not larger than n. Incidentally, n is a normalized number of maximum amplitude. In the example of FIG. 5, n=8.

The first threshold S100-1 to the first threshold S100-M are collectively referred to as first thresholds. Since second thresholds can be calculated in the same manner as the first thresholds S100, description thereof will be omitted. The comparators 217 and 218 and the threshold calculator 216 are collectively referred to as a calculator.

The threshold calculator 216 calculates a first threshold, a second threshold and an addition/subtraction quantity using ones of Expression (1) to Expression (8) whenever a correction quantity is calculated. Alternatively, a table indicating the relationship among correction quantities, first thresholds, second thresholds and addition/subtraction quantities may be prepared in a not-shown memory in advance so that the threshold calculator 216 can calculate a first threshold, a second threshold and an addition/subtraction quantity from a correction quantity with reference to the table.

Thus, according to the receiver 2 in the second exemplary embodiment, even when the quantization errors of the A/D converters 111 and 112 are defined on a logarithmic scale, IQ imbalance correction can be performed by adders without use of any multiplier in the same manner as in the first exemplary embodiment when only the comparators 217 and 218 are added.

Power which cannot be adjusted in an analog portion is generally corrected by power correction of an I signal and a Q signal in a digital portion so that the correction quantity can be reduced. When power of a 4-bit signal is corrected, the power correction can be achieved with one first threshold and one second threshold if the correction quantity is within 1.92 dB. Thus, power correction can be carried out by addition processing of +0 or ±1.

Accordingly, the number of adders can be reduced so that it is possible to provide a receiver which is low in power consumption and small in circuit scale.

### (First Modification)

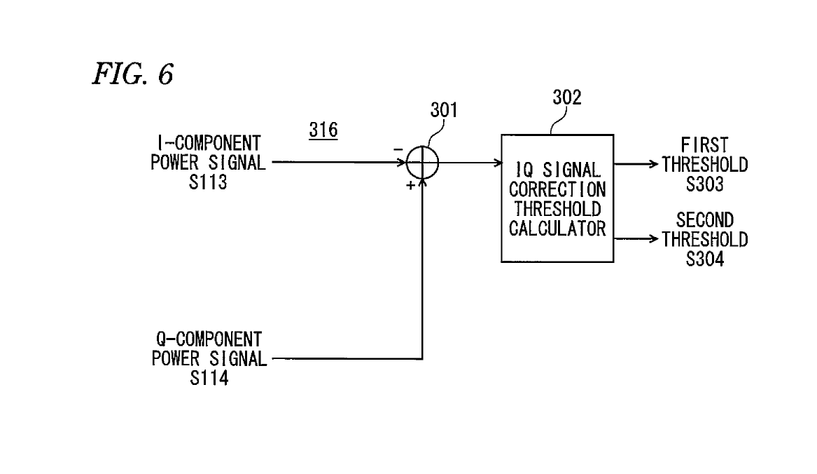

First Modification of this exemplary embodiment will be described with reference to FIG. 6. In the second exemplary embodiment, the target signal generator 201 generates a target signal and the threshold calculator 216 calculates a correction value from the target signal and an I-component power signal or a Q-component power signal. A threshold calculator 316 in this modification calculates a correction value from the I-component power signal or the Q-component power signal. Incidentally, a receiver 3 according to this exemplary embodiment has the same constituent members as those in the second exemplary embodiment shown in FIG. 3, except that the receiver 3 has a different threshold calculator. Thus, the receiver 3 will be described with reference to FIG. 3.

As shown in FIG. 6, the threshold calculator 316 does not have the target signal generator 201 but has an adder/subtracter 301 and an IQ signal correction threshold calculator 302. The adder/subtracter 301 calculates a difference between the I-component power signal and the Q-component power signal. The IQ signal correction threshold calculator 302 sets the difference calculated by the adder/subtracter 301 as a correction value. That is, the correction value is expressed by G=g when g designates the difference between the I-component power signal and the Q-component power signal.

When the correction value is calculated from the I-component power signal or the Q-component power signal in this manner, the target signal generator 201 can be omitted so that it is possible to provide a receiver which is lower in power consumption and smaller in circuit scale. Although description has been described here in the case where the correction value for the receiver 2 is calculated, the correction value for the receiver 1 can be calculated in the same manner.

### Third Exemplary Embodiment

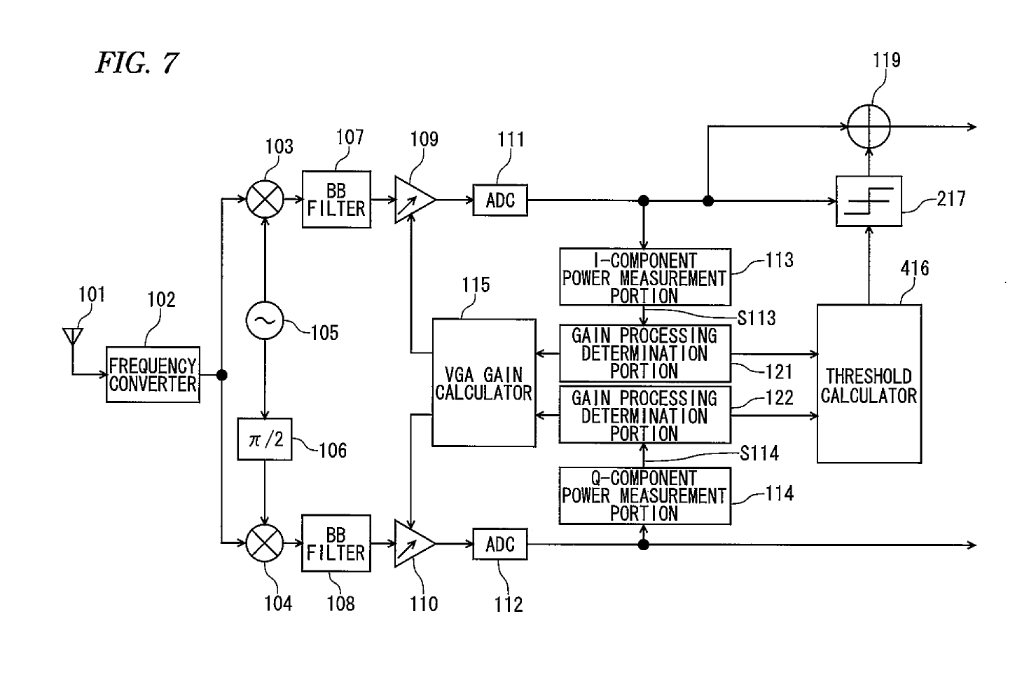

A receiver 4 according to a third exemplary embodiment of the invention will be described with reference to FIG. 7. In the first or second exemplary embodiment, configuration is made so that a correction quantity is calculated from a difference between a target value and an I-component power signal or a Q-component power signal. However, the correction quantity may be calculated to make the I-component power signal and the Q-component power signal equal to each other. The receiver 4 shown in FIG. 7 has the same configuration as the receiver 2 shown in FIG. 3, except that the receiver 4 does not have the comparator 218 and the adder 120 but has a different threshold calculator 416.

The threshold calculator 416 does not have a target signal generator but uses a different method for calculating a correction quantity G′ [dB]. The other configuration and operation of the threshold calculator 416 are the same as the threshold calculator 216 of the receiver 2. The correction quantity G′ is calculated using the I-component power signal S113 and the Q-component power signal S114. Specifically, the difference G′ between the I-component power signal S113 and the Q-component power signal S114 is set as a correction quantity.

In this manner, the correction quantity G′ is calculated to make the I-component power signal and the Q-component power signal equal to each other, and the digital I signal is corrected. Thus, the number of circuit elements can be further reduced so that the power consumption can be saved and the circuit scale can be reduced. Incidentally, although description has been made here in the case where the digital I signal is corrected, the digital Q signal may be corrected. In addition, the correction quantity for the receiver 1 shown in FIG. 1 may be calculated in the same manner.

### (Second Modification)

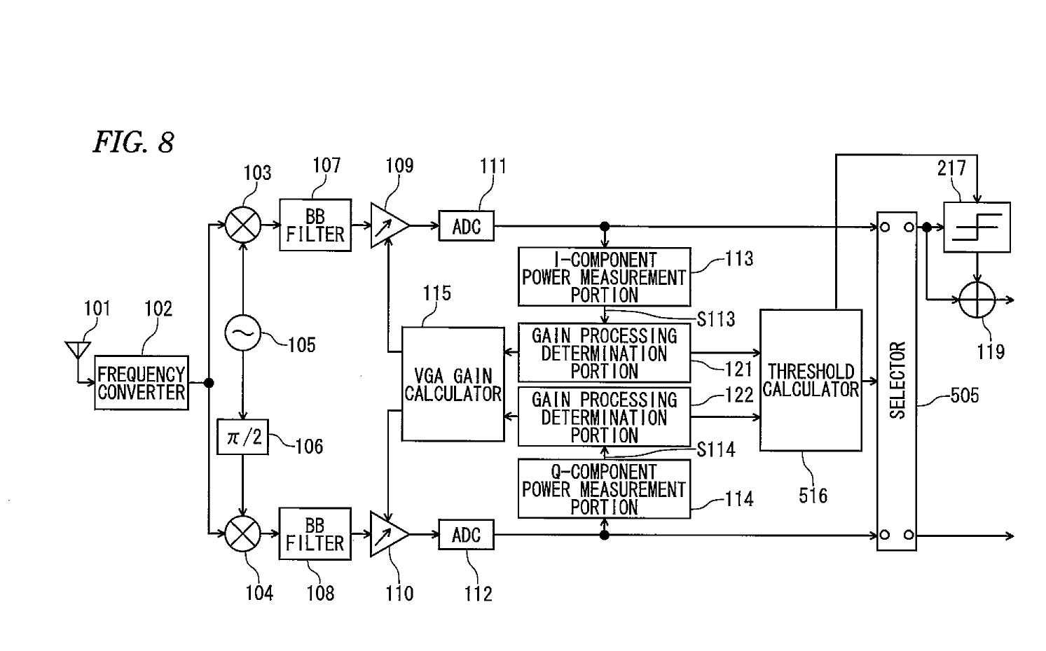

FIG. 8 shows a second modification of the third exemplary embodiment. A receiver 5 shown in FIG. 8 has a selector 505 in addition to the configuration of the receiver 4 in FIG. 7. Although IQ imbalance correction is performed only on the digital I signal in the receiver 4, in this modification, either the digital I signal or the digital Q signal is selected by the selector 505, and IQ imbalance correction is performed on the selected signal.

A threshold calculator 516 calculates a threshold from the correction quantity G′ and determines either the digital I signal or the digital Q signal to be selected. As a specific selection method, for example, there is a method in which a digital signal with a larger amplitude value is selected. When the threshold calculator 516 has a target signal generator as in the receiver 3 in FIG. 3, either the digital I signal or the digital Q signal is selected correspondingly to a larger one of a difference between the I-component power signal S113 and a target signal generated by the target signal generator and a difference between the Q-component power signal S114 and the target signal. The correction quantity G′ in this case is a value which is the larger one of the difference between the I-component power signal S113 and the target signal generated by the target generator and the difference between the Q-component power signal S114 and the target signal. The threshold calculator 516 sends a notification of the selected signal to the selector 505.

In accordance with the notification from the threshold calculator 516, the selector 505 outputs the signal selected by the threshold calculator 516 to the comparator 217 and the adder 119.

The comparator 217 compares a threshold calculated based on the correction value G′ by the threshold calculator 516 with the signal selected by the selector 505, and outputs a result of the comparison to the adder 119. The adder 119 adds an addition value to the signal selected by the selector 505 based on the result of the comparison. As a result, IQ imbalance correction is applied to the signal selected by the selector 505.

### Fourth Exemplary Embodiment

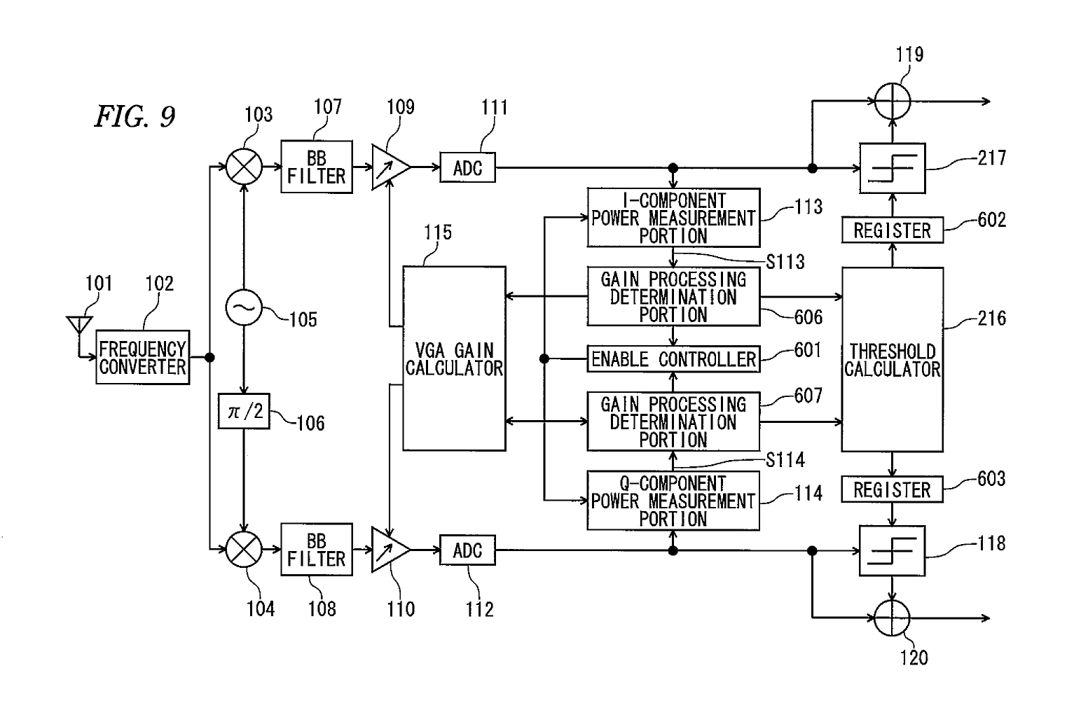

FIG. 9 shows a receiver 6 according to a fourth exemplary embodiment of the invention. In this exemplary embodiment, a receiver in which a preamble such as a packet signal is received as a received signal is assumed. In this exemplary embodiment, a first threshold and a second threshold are calculated while the preamble is being received.

The receiver 6 has the same configuration as the receiver 3 shown in FIG. 3, except that the receiver 6 has gain processing determination portions 606 and 607 in place of the gain processing determination portions 121 and 122 and further has an enable controller 601 and registers 602 and 603.

When determination is made that the gain adjustment in the VGAs 109 and 110 has been completed, the gain processing determination portions 606 and 607 output the I-component power signal S113 and the Q-component power signal S114 to the threshold calculator 216 while sending a completion notification to the enable controller 601.

The enable controller 601 turns off ENABLE to access to the I-component power measurement portion 113 and the Q-component power measurement portion 114. On receiving a completion signal indicating a message that reception of a packet signal has been completed from a not-shown signal processing portion, the enable controller 601 turns on ENABLE again to be ready for arrival of a next packet signal.

The threshold calculator 216 outputs a first threshold S100 and a second threshold S101 in accordance with the I-component power signal S113 and the Q-component power signal S114. The outputted thresholds are stored in the registers 602 and 603.

The threshold calculator 216 performs processing for calculating thresholds only when the VGA gain adjustment has been completed and the I-component power signal S113 and the Q-component power signal S114 have been outputted from the gain processing determination portions 606 and 607. That is, only when a preamble is received in each packet signal, the threshold calculator 216 operates to update the thresholds stored in the registers 602 and 603. When a payload in the packet signal following the preamble is being received, the first threshold S100 and the second threshold S101 stored in the registers 602 and 603 are compared with the amplitude values of the digital I signal and the digital Q signal in the comparators 217 and 218. Results of the comparison are outputted to the adders 119 and 120 as addition values, and addition processing on the digital I signal and the digital Q signal is performed to carry out IQ imbalance correction.

In the aforementioned manner, according to the fourth exemplary embodiment, similar effect to that in the second exemplary embodiment can be obtained, while the operations of the power measurement portions, the gain processing determination portions, the threshold calculator, etc. can be suspended when a payload of each packet signal is being received. Thus, the power consumption can be further saved.

Incidentally, the invention is not limited to the aforementioned exemplary embodiments per se and constituent members may be modified to embody the invention without departing from the gist of the invention in a practical stage. Constituent members disclosed in the aforementioned exemplary embodiments may be combined suitably to form various inventions. For example, some constituent members may be removed from all constituent members disclosed in each exemplary embodiment. In addition, constituent members in different exemplary embodiments may be combined suitably.

What is claimed is:

1. A receiver comprising:
a first mixer configured to generate an in-phase signal from a received signal;
a second mixer configured to generate a quadrature signal from the received signal;
a first A/D converter configured to convert the in-phase signal into a digital in-phase signal;
a second A/D converter configured to convert the quadrature signal into a digital quadrature signal;
a calculator configured to calculate an addition/subtraction quantity based on a correction quantity, which is based on an amplitude value of at least one of the digital in-phase signal and the digital quadrature signal, and a quantization error of at least one of the first A/D converter and the second A/D converter; and
an addition/subtraction unit configured to add or subtract the addition/subtraction quantity to or from at least one of the digital in-phase signal and the digital quadrature signal.

2. The receiver according to claim 1,
wherein the calculator comprises a comparator configured to compare an amplitude value of at least one of the digital in-phase signal and the digital quadrature signal with a first threshold;
wherein the calculator sets a k^{th} bit value indicating a k^{th} largest amplitude value as the first threshold and sets the addition/subtraction quantity at M, wherein k and M are natural numbers, when a difference between the correction quantity and a difference in amplitude between a k−1^{th} largest amplitude value and a k−M−1^{th} largest amplitude value is within a range of a maximum quantization error of a k−M−1^{th} bit value indicating the k−M−1^{th} largest amplitude value and a difference between the correction quantity and a difference in amplitude between the k^{th} largest amplitude value and a k−M^{th} largest amplitude value is out of a range of a maximum quantization error of a k−M^{th} bit value indicating the k−M^{th} largest amplitude value; and
wherein the addition/subtraction unit adds or subtracts the addition/subtraction quantity to or from at least one of the digital in-phase signal and the digital quadrature signal when the amplitude value of at least one of the digital in-phase signal and the digital quadrature signal is larger than the first threshold.

3. The receiver according to claim 2,
wherein the calculator sets a t^{th} bit value, wherein t is a natural numbers satisfying k<t, indicating at t^{th} largest amplitude value as a second threshold when a difference between the correction quantity and a difference in amplitude between a t−1^{th} largest amplitude value and a t−M−2^{th} largest amplitude value is within a range of a maximum quantization error of a t−M−2^{th} bit value indicating the t−M−2^{th} largest amplitude value and a difference between the correction quantity and a difference in amplitude between the t^{th} largest amplitude value and a t−M−1^{th} largest amplitude value is out of a range of a maximum quantization error of a t−M−1^{th} bit value indicating the t−M−1^{th} largest amplitude value;
wherein the comparator compares the amplitude value of at least one of the digital in-phase signal and the digital quadrature signal with the second threshold; and
wherein the addition/subtraction unit adds or subtracts the addition/subtraction quantity to or from at least one of the digital in-phase signal and the digital quadrature signal when the amplitude value of at least one of the digital in-phase signal and the digital quadrature signal is larger than the first threshold but not larger than the second threshold.

4. The receiver according to claim 1,
wherein the calculator sets the addition/subtraction quantity at zero when the correction quantity is within a range of a maximum quantization error in a k^{th} bit value, wherein k is a natural number, indicating a k^{th} largest amplitude value in at least one of the first A/D converter and the second A/D converter, and sets the addition/subtraction quantity as not smaller than +1 when the correction quantity is out of the range.

5. The receiver according to claim 4,
wherein the calculator sets the addition/subtraction quantity at M, wherein M is a natural number, when a difference between the correction quantity and a difference in amplitude between the k^{th} largest amplitude value and a k−M^{th} largest amplitude value is within the range of the maximum quantization error in the k−M^{th} bit value indicated by the k−M^{th} largest amplitude value.

6. The receiver according to claim 2,
wherein the calculator calculates the first threshold and the addition/subtraction quantity using a portion corresponding to a preamble of the received signal.
